(19) United States
(12) Patent Application Publication
(10) Pub. No.: US 2026/0261683 A1
(43) Pub. Date: Sep. 3, 2026

(54) A METHOD, AN APPARATUS AND A COMPUTER PROGRAM PRODUCT FOR VIDEO CODING

(71) Applicant: Nokia Technologies Oy, Espoo (FI)

(72) Inventors: Francesco CRICRÌ, Tampere (FI); Honglei ZHANG, Tampere (FI); Miska Matias HANNUKSELA, Tampere (FI); Ramin GHAZNAVI YOUVALARI, Tampere (FI); Nannan ZOU, Tampere (FI); Maria Claudia SANTAMARIA GOMEZ, Tampere (FI); Ruiying YANG, Tampere (FI)

(21) Appl. No.: 18/879,761

(22) PCT Filed: May 15, 2023
(86) PCT No.: PCT/EP2023/062866

§ 371 Date: Dec. 28, 2024

(30) Foreign Application Priority Data
Jun. 30, 2022 (FI) 20225599

(51) Int. Cl. H04N 19/136; H04N 19/117; H04N 19/172; H04N 19/42; H04N 19/51; H04N 19/82

(52) U.S. Cl. CPC H04N 19/136; H04N 19/117; H04N 19/172; H04N 19/42; H04N 19/51; H04N 19/82

(57) ABSTRACT

The embodiments relate to a method for receiving one or more target data units and one or more auxiliary data units as input to a neural network based processor; determining target features based at least on said one or more target data units and determining auxiliary features based at least on said one or more auxiliary data units, by one or more first portions of the neural network based processor; combining the determined features or data derived from the determined features by a combination operation; and providing an output of the combination operation to a second portion of the neural network based processor. The embodiments also relate to a method for training the neural network based processor and for technical equipment for implementing any of the methods.

The project leading to this application has received funding from the ECSEL Joint Undertaking (JU) under grant agreement No 876019. The JU receives support from the European Union's Horizon 2020 research and innovation programme and Germany, Netherlands, Austria, Romania, France, Sweden, Cyprus, Greece, Lithuania, Portugal, Italy, Finland, Turkey.

### TECHNICAL FIELD

The present solution generally relates to image and video processing.

### BACKGROUND

One of the elements in image and video compression is to compress data while maintaining the quality to satisfy human perceptual ability. However, in recent development of machine learning, machines can replace humans when analyzing data for example in order to detect events and/or objects in video/image. The present embodiments can be utilized in Video Coding for Machines, but also in other use cases.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for receiving one or more target data units and one or more auxiliary data units as input to a neural network based processor; means for determining target features based at least on said one or more target data units and means for determining auxiliary features based at least on said one or more auxiliary data units, by one or more first portions of the neural network based processor; means for combining the determined features or data derived from the determined features by a combination operation; and means for providing an output of the combination operation to a second portion of the neural network based processor.

According to a second aspect, there is provided an apparatus for training a neural network based processor, comprising means for determining target features based on one or more target data units; means for determining auxiliary features based on one or more auxiliary data units; means for determining a loss term based at least on said target features and said auxiliary features, or between data derived from said target features and said auxiliary features; and means for training the neural network based processor to minimize a loss function comprising said determined loss term.

According to a third aspect, there is provided a method, comprising receiving one or more target data units and one or more auxiliary data units as input to a neural network based processor; determining target features based at least on said one or more target data units and means for determining auxiliary features based at least on said one or more auxiliary data units, by one or more first portions of the neural network based processor; combining the determined features or data derived from the determined features by a combination operation; and providing an output of the combination operation to a second portion of the neural network based processor.

According to a fourth aspect, there is provided a method for training a neural network based processor, comprising determining target features based on one or more target data units; determining auxiliary features based on one or more auxiliary data units; determining a loss term based at least on said target features and said auxiliary features, or between data derived from said target features and said auxiliary features; and training the neural network based processor to minimize a loss function comprising said determined loss term.

According to a fifth aspect, there is provided an apparatus comprising at least one processor, memory including computer program code, the memory and the computer program code configured to, with the at least one processor, cause the apparatus to perform at least the following: receive one or more target data units and one or more auxiliary data units as input to a neural network based processor; determine target features based at least on said one or more target data units and means for determining auxiliary features based at least on said one or more auxiliary data units, by one or more first portions of the neural network based processor; combine the determined features or data derived from the determined features by a combination operation; and provide an output of the combination operation to a second portion of the neural network based processor.

According to a sixth aspect, there is provided an apparatus for training a neural network based processor, the apparatus comprising at least one processor, memory including computer program code, the memory and the computer program code configured to, with the at least one processor, cause the apparatus to perform at least the following: determine target features based on one or more target data units; determine auxiliary features based on one or more auxiliary data units; determine a loss term based at least on said target features and said auxiliary features, or between data derived from said target features and said auxiliary features; and train the neural network based processor to minimize a loss function comprising said determined loss term.

According to a seventh aspect, there is provided computer program product comprising computer program code configured to, when executed on at least one processor, cause an apparatus or a system to: receive one or more target data units and one or more auxiliary data units as input to a neural network based processor; determine target features based at least on said one or more target data units and means for determining auxiliary features based at least on said one or more auxiliary data units, by one or more first portions of the neural network based processor; combine the determined features or data derived from the determined features by a combination operation; and provide an output of the combination operation to a second portion of the neural network based processor.

According to an eighth aspect, there is provided computer program product comprising computer program code configured to, when executed on at least one processor, cause an apparatus or a system to: determine target features based on one or more target data units; determine auxiliary features based on one or more auxiliary data units; determine a loss term based at least on said target features and said auxiliary features, or between data derived from said target features and said auxiliary features; and train the neural network based processor to minimize a loss function comprising said determined loss term.

According to an embodiment, the combination operation comprises one of the following: a concatenation; an element-wise multiplication; a summation.

According to an embodiment, a prediction of the one or more target data units is also received as input.

According to an embodiment, the neural network based processor is one of the following: neural network based in-loop filter; neural network based post-processing filter; end-to-end learned neural network based decoder; or one of the neural networks in an end-to-end learned neural network based decoder.

According to an embodiment, one or more data units, or features extracted from said one or more data units are motion-compensated, and the motion-compensated data units are used as the one or more auxiliary data units or means for using the motion-compensated features as the one or more auxiliary features.

According to an embodiment, the one or more target data units are one or more of the following: an image, a decompressed image, a video frame, a decompressed video frame; and wherein the one or more auxiliary data units are one of the following: other images, other decompressed images, other video frames, other decompressed video frames, respectively.

According to an embodiment, the one or more target data units are one of the following: a portion of an image, decompressed portion of an image, a portion of an image frame, a decompressed portion of an image frame; and wherein the one or more auxiliary data units are one of the following: other portions of the same image or one or more other images, other decompressed portions of the same image or one or more other images, other portions of the same video frame or one or more other video frames, other decompressed portions of the same video frame or one or more other video frames.

According to an embodiment, one or more auxiliary data units or auxiliary features are selected based at least on one or more selection criteria, wherein the selection criteria is based at least on one of the following; a quality of the auxiliary data units; a resolution of auxiliary data units; location of the auxiliary unit on a certain temporal layer; role of the auxiliary data unit as a reference data; content of the auxiliary data unit; distance of the one or more auxiliary data unit compared to the one or more target data units.

According to an embodiment, selecting one or more auxiliary data units based at least on one or more selection criteria comprises selecting the one or more auxiliary data units that have a higher quality than the one or more target data units; or have a higher resolution than the one or more target data units; or are part of a lower temporal layer with respect to the one or more target data units; have similar content as the one or more target data units.

According to an embodiment, the selecting one or more auxiliary data units based at least on one or more selection criteria comprises selecting the one or more auxiliary data units by performing a hard or a soft attention operation based at least on one or more attention neural networks, wherein the result of the attention operations functions as a selection criterion.

According to an embodiment, the data derived from the determined target features or from the determined auxiliary features comprises statistical measurements of the features including one or more of the following: channel-wise mean; channel-wise standard-deviation; variance; Gram matrix.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a codec with neural network (NN) components;

FIG. 2 shows another example of a video coding system with neural network components;

FIG. 3 shows an example of a neural network-based end-to-end learned codec;

FIG. 4 shows an example of a neural network-based end-to-end learned video coding system;

FIG. 5 shows an example of a video coding for machines;

FIG. 6 shows an example of a pipeline for end-to-end learned system for video coding for machines;

FIG. 7 shows an example of training an end-to-end learned codec;

FIG. 8 shows a system according to an embodiment comprising a neural network based processor (NNP);

FIG. 9 shows a system according to an embodiment, where NNP is trained to minimize a loss function;

FIG. 10 shows an embodiment combining the embodiments of FIG. 8 and FIG. 9;

FIG. 11 shows a system according to an embodiment, where NNP is part of an end-to-end learned neural network based decoder;

FIG. 12 shows a high-level illustration of selecting one or more auxiliary data units;

FIG. 13 shows a system according to an embodiment further comprising VVC coding elements;

FIG. 14 shows a system according to an embodiment further comprising a downsampling operation;

FIG. 15 shows a system according to an embodiment further comprising a prediction NN;

FIG. 16 is a flowchart illustrating a method according to an embodiment;

FIG. 17 is a flowchart illustrating a method for training according to an embodiment; and

FIG. 18 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

Before discussing the present embodiments in more detailed manner, a short reference to related technology is given.

In the context of machine learning, a neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC. A reference software for VVC is the VVC Test Model (VTM).

A specification of the AV1 bitstream format and decoding process were developed by the Alliance of Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YCgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor A to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of the estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sub of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

A bitstream may be defined as a sequence of bits, which may in some coding formats or standards be in the form of a network abstraction layer (NAL) unit stream or a byte stream, that forms the representation of coded pictures and associated data forming one or more coded video sequences.

A bitstream format may comprise a sequence of syntax structures.

A syntax element may be defined as an element of data represented in the bitstream. A syntax structure may be defined as zero or more syntax elements present together in the bitstream in a specified order.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. It needs to be understood that embodiments may be applied but are not limited to the described types of parameter sets and embodiments could likewise be applied to any parameter set type.

A parameter set may be activated when it is referenced e.g., through its identifier. An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g., ALF, LMCS, or scaling list) and an identifier. In other words, different types of APSs have their own identifier value ranges.

An Adaptation Parameter Set (APS) may comprise parameters for decoding processes of different types, such as adaptive loop filtering or luma mapping with chroma scaling.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified. SEI messages are generally not extended in future amendments or versions of the standard.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Image and video codecs may use a set of filters to enhance the visual quality of the predicted visual content and can be applied either in-loop or out-of-loop, or both. In the case of in-loop filters, the filter applied on one block in the currently-encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content won't be as a source for prediction, and thus it may only impact the visual quality of the frames that are output by the decoder.

In-loop filters in a video/image encoder and decoder may comprise, but may not be limited to, one or more of the following:
deblocking filter (DBF);
sample adaptive offset (SAO) filter;
adaptive loop filter (ALF) for luma and/or chroma components;
cross-component adaptive loop filter (CC-ALF).

A deblocking filter may be configured to reduce blocking artefacts due to block-based coding. A deblocking filter may be applied (only) to samples located at prediction unit (PU) and/or transform unit (TU) boundaries, except at the picture boundaries or when disabled at slice and/or tiles boundaries. Horizontal filtering may be applied (first) for vertical boundaries, and vertical filtering may be applied for horizontal boundaries.

A sample adaptive offset (SAO) may be another in-loop filtering process that modifies decoded samples by conditionally adding an offset value to a sample (possibly to each sample), based on values in look-up tables transmitted by the encoder. SAO may have one or more (e.g., two) operation modes; band offset and edge offset modes. In the band offset mode, an offset may be added to the sample value depending on the sample amplitude. The full sample amplitude range may be divided into a number of bands (e.g., 32 bands), and sample values belonging to four of these bands may be modified by adding a positive or negative offset, which may be signalled for each coding tree unit (CTU). In the edge offset mode, the horizontal, vertical, and two diagonal gradients may be used for classification.

An Adaptive Loop Filter (ALF) may apply block-based filter adaptation. For example, for the luma component, one among 25 filters may be selected for each 4×4 block, based on the direction and activity of local gradients, which are derived using the samples values of that 4×4 block. The ALF classification may be performed on 2×2 block units, for instance. When all of the vertical, horizontal and diagonal gradients are below a first threshold value, the block may be classified as texture (not containing edges). Otherwise, the block may be classified to contain edges, a dominant edge direction may be derived from horizontal, vertical and diagonal gradients, and a strength of the edge (e.g., strong or weak) may be further derived from the gradient values. When a filter within a filter set has been selected based on the classification, the filtering may be performed by applying a 7×7 diamond filter, for example, to the luma component. An ALF filter set may comprise one filter for each chroma component, and a 5×5 diamond filter may be applied to the chroma components, for example. In an example, the filter coefficients use point-symmetry relative to the center point. An ALF design may comprise clipping the difference between the neighboring sample value and the current to-be-filtered sample is added, which provides adaptability related to both spatial relationship and value similarity between samples.

In an example, cross-component ALF (CC-ALF) uses luma sample values to refine each chroma component by applying an adaptive linear filter to the luma channel and then using the output of this filtering operation for chroma refinement. Filtering in CC-ALF is accomplished by applying a linear, diamond shaped filter to the luma channel.

In an approach, ALF filter parameters are signalled in Adaptation Parameter Set (APS). For example, in one APS, up to 25 sets of luma filter coefficients and clipping value indices, and up to eight sets of chroma filter coefficients and clipping value indices could be signalled. To reduce the overhead, filter coefficients of different classification for luma component can be merged. In slice header, the identifiers of the APSs used for the current slice are signaled.

In WC slice header, up to 7 ALF APS indices can be signaled to specify the luma filter sets that are used for the current slice. The filtering process can be further controlled at coding tree block (CTB) level. A flag is signalled to indicate whether ALF is applied to a luma CTB. A filter set among 16 fixed filter sets and the filter sets from APSs selected in the slice header may be selected per each luma CTB by the encoder and may be decoded per each luma CTB by the decoder. A filter set index is signaled for a luma CTB to indicate which filter set is applied. The 16 fixed filter sets are pre-defined in the WC standard and hardcoded in both the encoder and the decoder. The 16 fixed filter sets may be referred to as the pre-defined ALFs.

A feature known as luma mapping with chroma scaling (LMCS) is included in H.266/VC. The luma mapping (LM) part remaps luma sample values. It may be used to use a full luma sample value range (e.g., 0 to 1023, inclusive in bit depth equal to 10 bits per sample) in content that would otherwise occupy only a subset of the range.

The luma sample values of an input video signal to the encoder and output video signal from the decoder are represented in the original (unmapped) sample domain. Forward luma mapping maps luma sample values from the original sample domain to the mapped sample domain. Inverse luma mapping maps luma sample values from the mapped sample domain to the original sample domain.

In an example codec architecture, the processes in the mapped sample domain include inverse quantization, inverse transform, luma intra prediction and summing the luma prediction with the luma residue values. The processes in the original sample domain include in-loop filters (e.g., deblocking, SAO, ALF), inter prediction, and storage of pictures in the decoded picture buffer (DPB).

In an example decoder, one or more of the following steps may be performed:
Inverse quantization and inverse transform are applied to the decoded luma transform coefficients to produce the luma residues in the mapped sample domain, Y′ᵣₑₛ;
Reconstructed luma sample values in the mapped sample domain, Y′ᵣ, are obtained by summing Y′ᵣₑₛ with the corresponding predicted luma values in the mapped sample domain, Y′_{pred}.
For intra prediction, Y′_{pred} is directly obtained by performing intra prediction in mapped sample domain.
For inter prediction, the predicted luma values in original sample domain, Y_{pred}, are first obtained by motion compensation using reference pictures from the DPB, and then forward luma mapping is applied to produce the luma values in the mapped sample domain, Y′_{pred}.
Inverse luma mapping is applied to reconstructed values Y′ᵣ to produce reconstructed luma sample values in the original sample domain, which are processed by in-loop filters (deblocking, sample adaptive offset, and adaptive loop filter) before being stored in the DPB.

In VVC, LMCS syntax elements are signalled in an adaptation parameter set (APS) with aps_params_type equal to 1 (LMCS_APS). The value range for an adaptation parameter set identifier (aps_adaptation_parameter_set_id) is from 0 to 3, inclusive, for LMCS APSs. The use of LMCS can be enabled or disabled in a picture header. When LMCS is enabled in a picture header, the LMCS APS identifier value used for the picture (ph_lmcs_aps_id) is included in the picture header. Thus, the same LMCS parameters are used for entire picture. Note also that when LMCS is enabled in a picture header and a chroma format including the chroma components is in use, the chroma scaling part can be enabled or disabled in the picture header through ph_chroma_residual_scale_flag. When a picture has multiple slices, LMCS is further enabled or disabled in the slice header for each slice.

In VVC, LMCS data within an LMCS APS comprises syntax related to a piecewise linear model of up to 16 pieces for luma mapping. The luma sample value range of the piecewise linear forward mapping function is uniformly sampled into 16 pieces of same length OrgCW. For example, for a 10-bit input video, each of the 16 pieces contains OrgCW=64 input codewords. For each piece of index i, the number of output (mapped) codewords is defined as binCW[i]. binCW[i] is determined at the encoding process. The difference between binCW[i] and OrgCW is signalled in LMCS APS. The slopes scaleY[i] and invScaleY[i] of the functions FwdMap and InvMap are respectively derived as:

$$scaleY [ i ] = binCW [ i ] \div OrgCW$$

$$invScaleY [ i ] = OrgCW \div binCW [ i ]$$

Recently, neural networks (NNs) have been used in the context of image and video compression, by following mainly two approaches.

In one approach, NNs are used to replace one or more of the components of a traditional codec such as WC/H.266. Here, term “traditional” refers to those codecs whose components and their parameters may not be learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

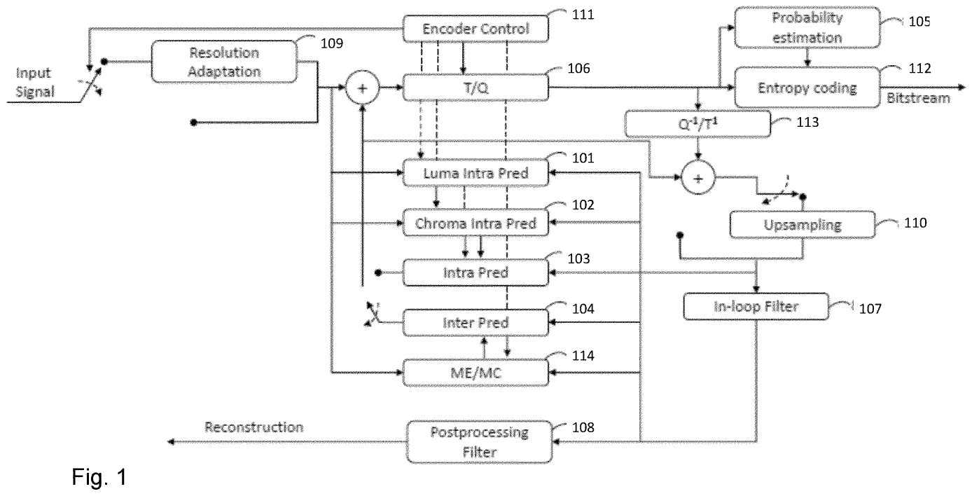

FIG. 1 illustrates examples of functioning of NNs as components of a traditional codec's pipeline, in accordance with an embodiment. In particular, FIG. 1 illustrates an encoder, which also includes a decoding loop. FIG. 1 is shown to include components described below:
A luma intra pred block or circuit 101. This block or circuit performs intra prediction in the luma domain, for example, by using already reconstructed data from the same frame. The operation of the luma intra pred block or circuit 101 may be performed by a deep neural network such as a convolutional auto-encoder.
A chroma intra pred block or circuit 102. This block or circuit performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.
An intra pred block or circuit 103 and inter-pred block or circuit 104. These blocks or circuit perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.
A probability estimation block or circuit 105 for entropy coding. This block or circuit performs prediction of probability for the next symbol to encode or decode, which is then provided to the entropy coding module 112, such as the arithmetic coding module, to encode or decode the next symbol. The operation of the probability estimation block or circuit 105 may be performed by a neural network.
A transform and quantization (T/Q) block or circuit 106. These are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.
An in-loop filter block or circuit 107. Operations of the in-loop filter block or circuit 107 is performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.
A postprocessing filter block or circuit 108. The postprocessing filter block or circuit 108 may be performed only at decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.
A resolution adaptation block or circuit 109: this block or circuit may downsample the input video frames, prior to encoding. Then, in the decoding loop, the reconstructed data may be upsampled, by the upsampling block or circuit 110, to the original resolution. The operation of the resolution adaptation block or circuit 109 block or circuit may be performed by a neural network such as a convolutional auto-encoder.
An encoder control block or circuit 111. This block or circuit performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.
An ME/MC block or circuit 114 performs motion estimation and/or motion compensation, which are two key operations to be performed when performing inter-frame prediction. ME/MC stands for motion estimation/motion compensation.

In another approach, commonly referred to as “end-to-end learned compression”, NNs are used as the main components of the image/video codecs. In this second approach, there are two main options:

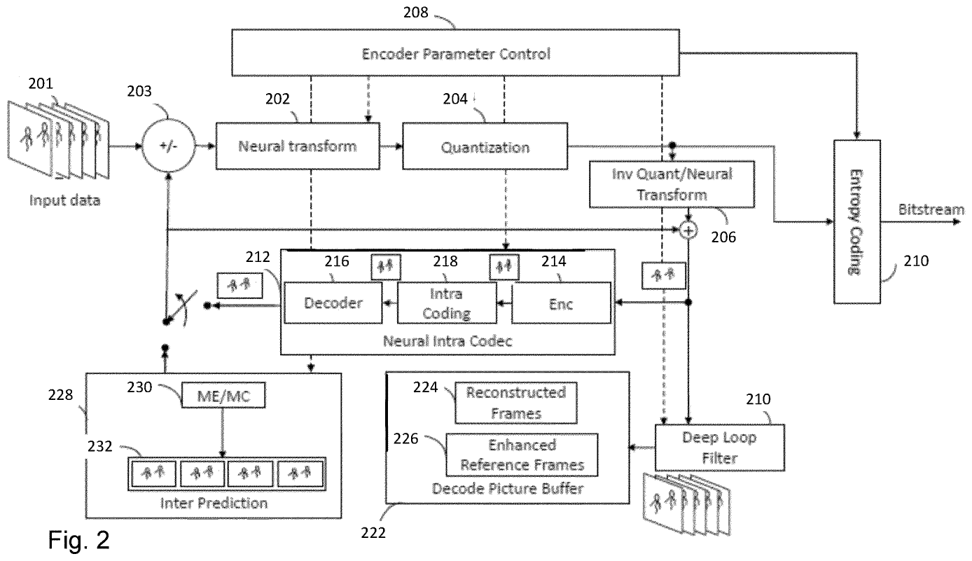

Option 1: re-use the video coding pipeline but replace most or all the components with NNs. Referring to FIG. 2, it illustrates an example of modified video coding pipeline based on a neural network, in accordance with an embodiment. An example of neural network may include, but is not limited to, a compressed representation of a neural network. FIG. 2 is shown to include following components:
A neural transform block or circuit 202: this block or circuit transforms the output of a summation/subtraction operation 203 to a new representation of that data, which may have lower entropy and thus be more compressible.
A quantization block or circuit 204: this block or circuit quantizes an input data 201 to a smaller set of possible values.
An inverse transform and inverse quantization blocks or circuits 206. These blocks or circuits perform the inverse or approximately inverse operation of the transform and the quantization, respectively.
An encoder parameter control block or circuit 208. This block or circuit may control and optimize some or all the parameters of the encoding process, such as parameters of one or more of the encoding blocks or circuits.
An entropy coding block or circuit 210. This block or circuit may perform lossless coding, for example based on entropy. One popular entropy coding technique is arithmetic coding.
A neural intra-codec block or circuit 212. This block or circuit may be an image compression and decompression block or circuit, which may be used to encode and decode an intra frame. An encoder 214 may be an encoder block or circuit, such as the neural encoder part of an auto-encoder neural network. A decoder 216 may be a decoder block or circuit, such as the neural decoder part of an auto-encoder neural network. An intra-coding block or circuit 218 may be a block or circuit performing some intermediate steps between encoder and decoder, such as quantization, entropy encoding, entropy decoding, and/or inverse quantization.
A deep loop filter block or circuit 220. This block or circuit performs filtering of reconstructed data, in order to enhance it.
A decode picture buffer block or circuit 222. This block or circuit is a memory buffer, keeping the decoded frame, for example, reconstructed frames 224 and enhanced reference frames 226 to be used for inter prediction.
An inter-prediction block or circuit 228. This block or circuit performs inter-frame prediction, for example, predicts from frames, for example, frames 232, which are temporally nearby. An ME/MC 230 performs motion estimation and/or motion compensation, which are two key operations to be performed when performing inter-frame prediction. ME/MC stands for motion estimation/motion compensation.

Option 2: re-design the whole pipeline, as follows.
Encoder NN is configured to perform a non-linear transform;
Quantization and lossless encoding of the encoder NN's output;
Lossless decoding and dequantization;
Decoder NN is configured to perform a non-linear inverse transform.

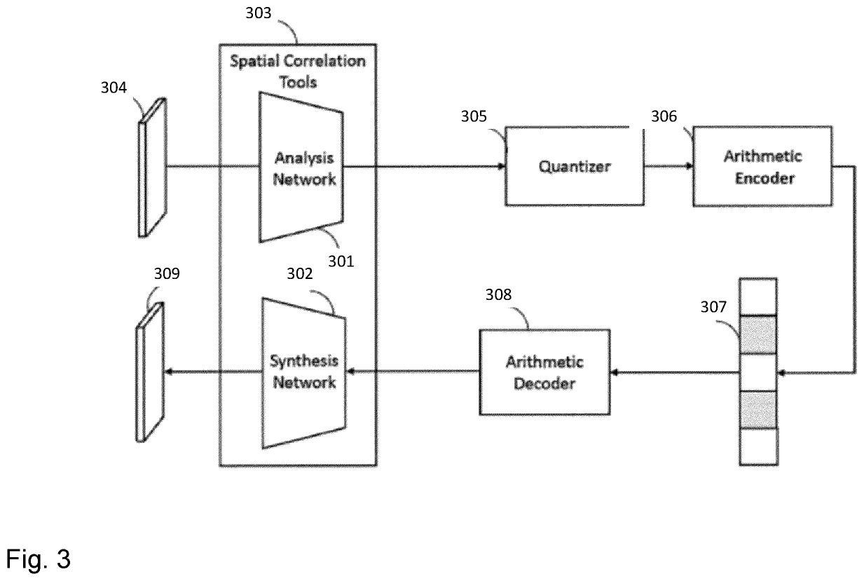

An example of option 2 is described in detail in FIG. 3 which shows an encoder NN and a decoder NN being parts of a neural auto-encoder architecture, in accordance with an example. In FIG. 3, the Analysis Network 301 is an Encoder NN, and the Synthesis Network 302 is the Decoder NN, which may together be referred to as spatial correlation tools 303, or as neural auto-encoder.

As shown in FIG. 3, the input data 304 is analyzed by the Encoder NN (Analysis Network 301), which outputs a new representation of that input data. The new representation may be more compressible. This new representation may then be quantized, by a quantizer 305, to a discrete number of values. The quantized data is then lossless encoded, for example by an arithmetic encoder 306, thus obtaining a bitstream 307. The example shown in FIG. 3 includes an arithmetic decoder 308 and an arithmetic encoder 306. The arithmetic encoder 306, or the arithmetic decoder 308, or the combination of the arithmetic encoder 306 and arithmetic decoder 308 may be referred to as arithmetic codec in some embodiments. On the decoding side, the bitstream is first lossless decoded, for example, by using the arithmetic codec decoder 308. The lossless decoded data is dequantized and then input to the Decoder NN, Synthesis Network 302. The output is the reconstructed or decoded data 309.

In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error(f1, f2), where f1 and f2 are the features extracted by a pretrained neural network for the input data and the decoded data, respectively, and error( ) is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. By “compressing”, we mean reducing the number of bits output by the encoding stage.

When an entropy-based lossless encoder is used, such as an arithmetic encoder, the rate loss typically encourages the output of the Encoder NN to have low entropy. Example of rate losses are the following:
A differentiable estimate of the entropy;
A sparsification loss, i.e., a loss that encourages the output of the Encoder NN or the output of the quantization to have many zeros. Examples are L0 norm, L1 norm, L1 norm divided by L2 norm;
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights may be considered to be hyper-parameters of the training session and may be set manually by the person designing the training session, or automatically for example by grid search or by using additional neural networks.

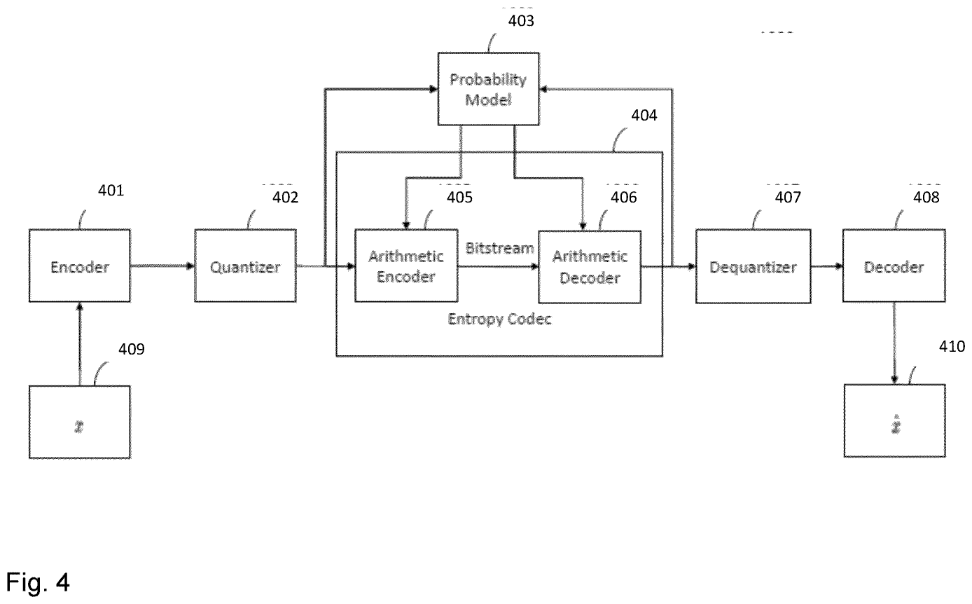

As shown in FIG. 4, a neural network-based end-to-end learned video coding system may contain an encoder 401, a quantizer 402, a probability model 403, an entropy codec 420 (for example arithmetic encoder 405/arithmetic decoder 406), a dequantizer 407, and a decoder 408. The encoder 401 and decoder 408 may be two neural networks, or mainly comprise neural network components. The probability model 403 may also comprise mainly neural network components. Quantizer 402, dequantizer 407 and entropy codec 420 may not be based on neural network components, but they may also comprise neural network components, potentially.

On the encoder side, the encoder component 401 takes a video x 409 as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). Please note that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information.

The quantizer component 402 quantizes the latent representation into discrete values given a predefined set of quantization levels. Probability model 403 and arithmetic codec component 420 work together to perform lossless compression for the quantized latent representation and generate bitstreams to be sent to the decoder side. Given a symbol to be encoded into the bitstream, the probability model 403 estimates the probability distribution of all possible values for that symbol based on a context that is constructed from available information at the current encoding/decoding state, such as the data that has already been encoded/decoded. Then, the arithmetic encoder 405 encodes the input symbols to bitstream using the estimated probability distributions.

On the decoder side, opposite operations are performed. The arithmetic decoder 406 and the probability model 403 first decode symbols from the bitstream to recover the quantized latent representation. Then the dequantizer 407 reconstructs the latent representation in continuous values and pass it to decoder 408 to recover the input video/image. Note that the probability model 403 in this system is shared between the encoding and decoding systems. In practice, this means that a copy of the probability model 403 is used at encoder side, and another exact copy is used at decoder side.

In this system, the encoder 401, probability model 403, and decoder 408 may be based on deep neural networks. The system may be trained in an end-to-end manner by minimizing the following rate-distortion loss function:

$$L = D + λ R ,$$

where D is the distortion loss term, R is the rate loss term, and A is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 403 and arithmetic encoder/decoder 405, 406. The system loss function contains only the rate loss, since the distortion loss is always zero (i.e., no loss of information).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which contains one or more machines, and runs these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

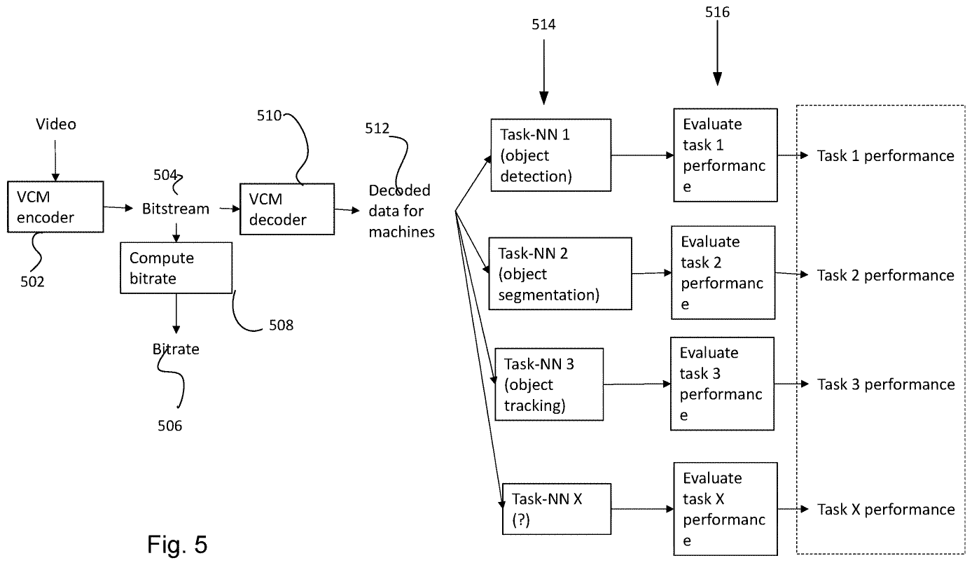

FIG. 5 is a general illustration of the pipeline of Video Coding for Machines. A VCM encoder 502 encodes the input video into a bitstream 504. A bitrate 506 may be computed 508 from the bitstream 504 in order to evaluate the size of the bitstream. A VCM decoder 510 decodes the bitstream output by the VCM encoder 502. In FIG. 5, the output of the VCM decoder 510 is referred to as “Decoded data for machines” 512. This data may be considered as the decoded or reconstructed video. However, in some implementations of this pipeline, this data may not have same or similar characteristics as the original video which was input to the VCM encoder 502. For example, this data may not be easily understandable by a human when rendering the data onto a screen. The output of VCM decoder is then input to one or more task neural networks 514. In the figure, for the sake of illustrating that there may be any number of task-NNs 514, there are three example task-NNs, and a non-specified one (Task-NN X). The goal of VCM is to obtain a low bitrate representation of the input video while guaranteeing that the task-NNs still perform well in terms of the evaluation metric 516 associated to each task.

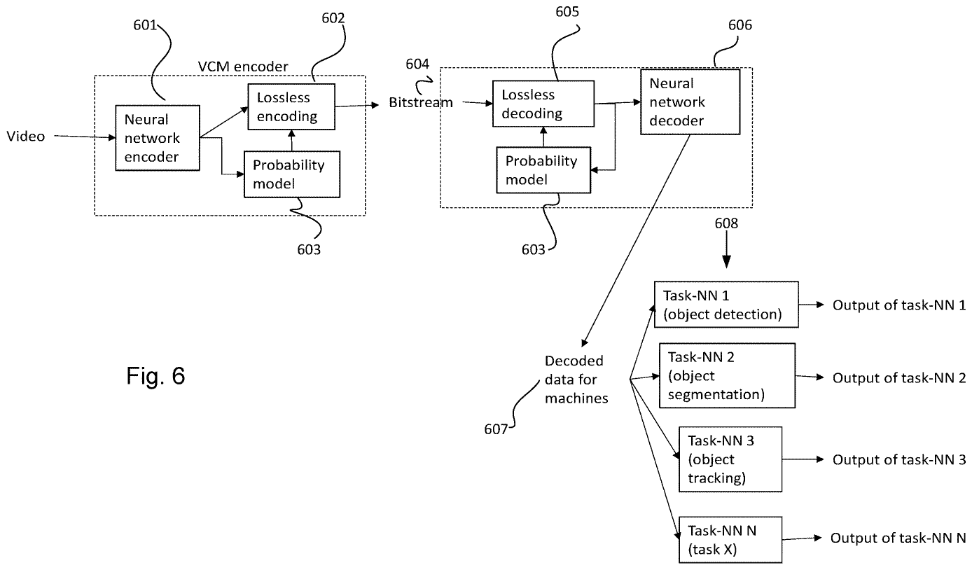

One of the possible approaches to realize video coding for machines is an end-to-end learned approach. In this approach, the VCM encoder and VCM decoder mainly consist of neural networks. FIG. 6 illustrates an example of a pipeline for the end-to-end learned approach. The video is input to a neural network encoder 601. The output of the neural network encoder 601 is input to a lossless encoder 602, such as an arithmetic encoder, which outputs a bitstream 604. The output of the neural network encoder 601 may be input also to a probability model 603 which provides to the lossless encoder 602 with an estimate of the probability of the next symbol to be encoded by the lossless encoder 602. The probability model 603 may be learned by means of machine learning techniques, for example it may be a neural network. At decoder-side, the bitstream 604 is input to a lossless decoder 605, such as an arithmetic decoder, whose output is input to a neural network decoder 606. The output of the lossless decoder 605 may be input to a probability model 603, which provides the lossless decoder 605 with an estimate of the probability of the next symbol to be decoded by the lossless decoder 605. The output of the neural network decoder 606 is the decoded data for machines 607, that may be input to one or more task-NNs 608.

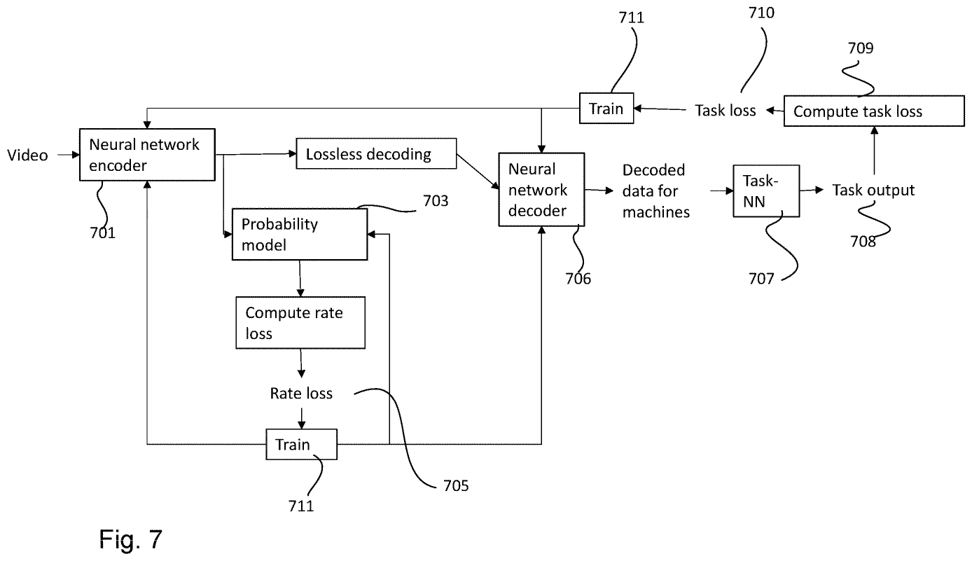

FIG. 7 illustrates an example of how the end-to-end learned system may be trained for the purpose of video coding for machines. For the sake of simplicity, only one task-NN 707 is illustrated. A rate loss 705 may be computed from the output of the probability model 703. The rate loss 705 provides an approximation of the bitrate required to encode the input video data. A task loss 710 may be computed 709 from the output 708 of the task-NN 707.

The rate loss 705 and the task loss 710 may then be used to train 711 the neural networks used in the system, such as the neural network encoder 701, the probability model 703, the neural network decoder 706. Training may be performed by first computing gradients of each loss with respect to the trainable neural networks' parameters that are contributing or affecting the computation of that loss. The gradients are then used by an optimization method, such as Adam, for updating the trainable parameters of the neural networks.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

In some video codecs, a neural network may be used as a filter in the decoding loop, and it may be referred to as neural network loop filter, or neural network in-loop filter. The NN loop filter may replace all other loop filters of an existing video codec or may represent an additional loop filter with respect to the already present loop filters in an existing video codec. In the context of image and video enhancement, a neural network may be used as post-processing filter, for example applied to the output of an image or video decoder in order to remove or reduce coding artifacts.

A post-processing filter is taken as an example of a use case, where the task of the filter is to enhance the quality of an input video frame that has been decoded by a video decoder. The input data provided to a filter may include the frame to be filtered, and some additional data related to that frame or to the encoding or decoding process. In one example, the additional data includes data derived from a Quantization Parameter (QP) value that was used by a video encoder for encoding the frame. In another example, the additional data includes data derived from the block partitioning process performed by an image/video encoder.

Another possible source of auxiliary data may include other video frames that share some characteristics with the frame to be filtered and also comprise useful information that may improve the filtering performance. However, it is not straightforward how to extract and utilize the useful information from the auxiliary data for the purpose of improving the filtering performance. The present embodiments are targeted to solve this drawback.

The present embodiments provide alternatives for the system architecture and/or the training of a neural network based processor (NNP) which allows the NNP to improve its performance on target input data by effectively using auxiliary input data. A least some of the embodiments being discussed in the following, relate to a case of enhancing an image or a video, where the image or video may have been compressed and decompressed by a codec. For the sake of simplicity, in at least some of the embodiments, video is used as an example of the data type. However, instead of video, other types of data can be used, for example, images, audio, etc. It is to be understood that at least some of the embodiments may be applied to any use case where a data unit is processed by a neural network based processor.

An encoder-side device performs a compression or encoding operation of an input video by using a video encoder. The output of the video encoder is a bitstream representing the compressed video. A decoder-side device performs decompression or decoding operation of the compressed video by using a video decoder. The output of the video decoder may be referred to as decoded video. The decoded video may be post-processed by one or more post-processing operations, such as a post-processing filter. The output of the one or more post-processing operations may be referred to as post-processed video.

The encoder-side device may also include at least some decoding operations, for example, in a coding loop, and/or at least some post-processing operations. According to an example, the encoder may include all the decoding operations and any post-processing operations. The encoder-side device and the decoder-side device may be the same physical device, or different physical devices.

The decoder or the decoder-side device may contain one or more neural networks. Some examples of such neural networks are the following:
A post-processing NN filter (also referred to here as post-filter, or NN post-filter, or post-filter NN), which takes as input at least one of the outputs of an end-to-end learned decoder or of a conventional decoder (i.e., a decoder not comprising neural networks or other components leaned from data) or of a hybrid decoder (i.e., a decoder comprising one or more neural networks or other components learned from data).
A NN in-loop filter (also referred to here as in-loop NN filter, or NN loop filter, or loop NN filter), used within an end-to-end learned decoder, or within a hybrid decoder.
A learned probability model (e.g., a NN) that is used for providing estimates of probabilities of symbols to be encoded and/or decoded by a lossless coding module, within an end-to-end learned codec or within a hybrid codec.
A decoder neural network for an end-to-end learned codec.

In the following, a neural network based processor (NNP) performing a certain task one or more inputs is used as an example.

According to an example, the NNP is an in-loop filter of a codec, where the codec may be a modified version of a traditional codec (such as a codec conforming to the H.266NVC standard specification) or an end-to-end learned codec, and where the in-loop filter may perform quality enhancement. Alternatively, the NNP is an in-loop filter of a codec, where the codec may be a modified version of a traditional codec (such as a codec conforming to the H.266/VVC standard specification) or an end-to-end learned codec, and where the in-loop filter may perform upsampling.

According to another example, the NNP is a post-processing filter, where the input to the NNP is one of the outputs of a traditional codec or one of the outputs of an end-to-end learned codec, and where the post-processing filter may perform quality enhancement. Alternatively, the post-processing filter may perform upsampling.

According to another example, the NNP performs a discriminative task such as image classification, object detection, object segmentation, instance segmentation, etc.

According to another example, the NNP performs a generative task, such as inpainting, interpolation, style transfer, etc.

In one embodiment, an NNP gets as input a target data unit (target DU) and one or more auxiliary data units (auxiliary DUs). One or more first portions of the NNP compute features based at least on the target DU (referred to as target features) and features based at least on the one or more auxiliary DUs (referred to as auxiliary features). The features or data derived from the features are combined by a combination operation. The output of the combination operation is provided as input to a second portion of the NNP. The one or more first portions of the NNP may comprise the same components, such as the same neural network layers, or may comprise different components, such as different neural network layers. In one example, the first portion used for extracting features based at least on the target DU comprises a neural network with same architecture, but different values of parameters compared to the first portion used for extracting features based at least on the one or more auxiliary DUs.

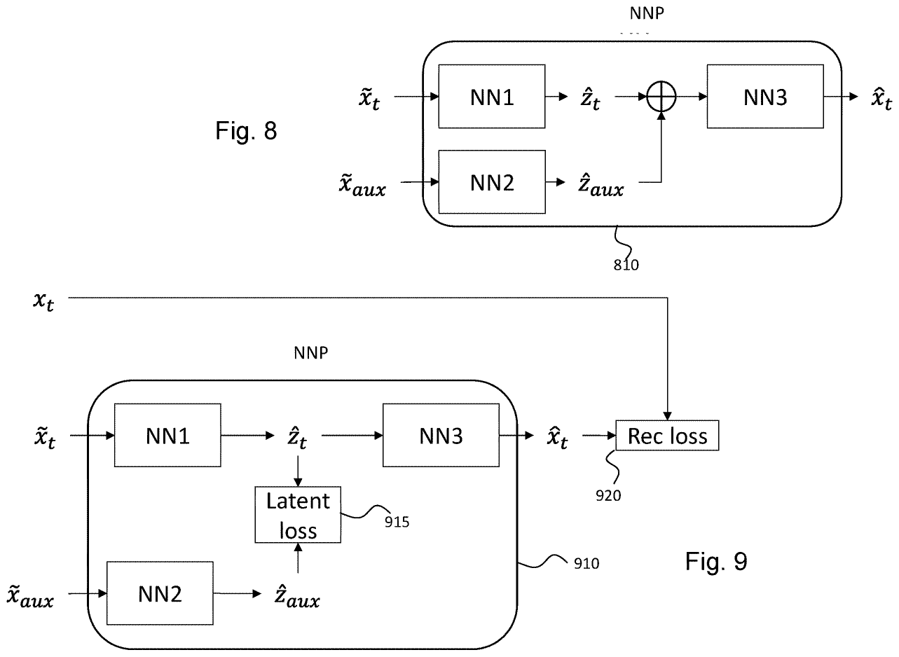

FIG. 8 illustrates an example of this embodiment. In the figure, \tilde{x}ₜ is a target DU, \tilde{x}ₐᵤₓ is an auxiliary DU, NN1 and NN2 are two first portions of the NNP 810, where NN1 computes target features \hat{z}ₜ based at least on \tilde{x}ₜ and where NN2 computes auxiliary features \hat{z}ₐᵤₓ based at least on \tilde{x}ₐᵤₓ, the combination operation is a summation (indicated by the + symbol), NN3 is a second portion of the NNP, \hat{x}ₜ is the output of the NNP 810. The first portions NN1 and NN2 may comprise different neural networks in terms of architecture and/or values of parameters. In the process of this figure, the NNP gets as input a target data unit (target DU) \tilde{x}ₜ and one or more auxiliary data units (auxiliary DUs) \tilde{x}ₐᵤₓ. One or more first portions NN1, NN2 of the NNP 810 compute features \hat{z}ₜ based at least on the target DU (referred to as target features) and features \hat{z}ₐᵤₓ based at least on the one or more auxiliary DUs (referred to as auxiliary features). The features or data derived from the features are combined by a combination operation. The output of the combination operation is provided as input to a second portion NN3 of the NNP 810.

Each of the first portions NN1, NN2 of the NNP 810 may comprise one or more neural network layers, such as convolutional layers, non-linear functions such as Rectified Linear Units (ReLU), downsampling layers such as max pooling or strided convolution layers, etc.

The second portion NN3 of the NNP 810 may comprise one or more neural network layers, such as convolutional layers, non-linear functions such as Rectified Linear Units (ReLU), upsampling layers such as transpose convolutional layers, interpolation layers, pixel-shuffle layers, etc.

The combination operation may comprise a concatenation. For simplicity, both features and data derived from features may be referred to as features in some embodiments and examples. In one example, the target features and the auxiliary features may be concatenated along the feature-channel axis. Alternatively, the combination operation comprises an element-wise multiplication. The target features and the auxiliary features may be required to have same dimensionality. Yet, as a further alternative, the combination operation comprises a summation. The target features and the auxiliary features may be required to have same dimensionality.

FIG. 9 illustrates a second embodiment, where NNP 910 is trained to minimize a loss function, where the loss function comprises a loss term. The loss term may be determined based at least on target features (or data derived from target features) and on auxiliary features (or data derived from auxiliary features), where target feature may be computed based on a target data unit (target DU) and where auxiliary features may be computed based on one or more auxiliary data units (auxiliary DUs). According to example, the loss function is the Mean Squared Error (MSE) between the target features and the auxiliary features. According to another example, the loss function is the MSE between at least a portion of the target features and at least a portion of the auxiliary features. As shown in FIG. 9, two loss terms 915, 920 are computed. A first loss term 915, referred to as “Latent loss”, is computed based at least on the target features 2, and the auxiliary features \hat{z}ₐᵤₓ. An example of the first loss term 915 is MSE. A second loss term 920, referred to as “Rec Loss”, is computed based at least on the output of the NNP and the uncompressed version of the target DU, that is denoted as xₜ.

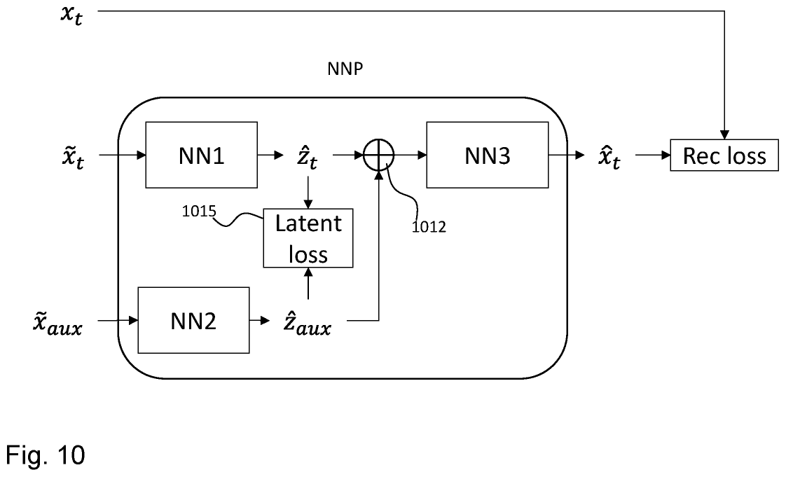

FIG. 10 illustrates another example that combines the previous embodiments, shown in FIGS. 8 and 9. In FIG. 10, the target features and the auxiliary features are used both for computing a loss term and for performing a combination operation (indicated by symbol (+) 1012).

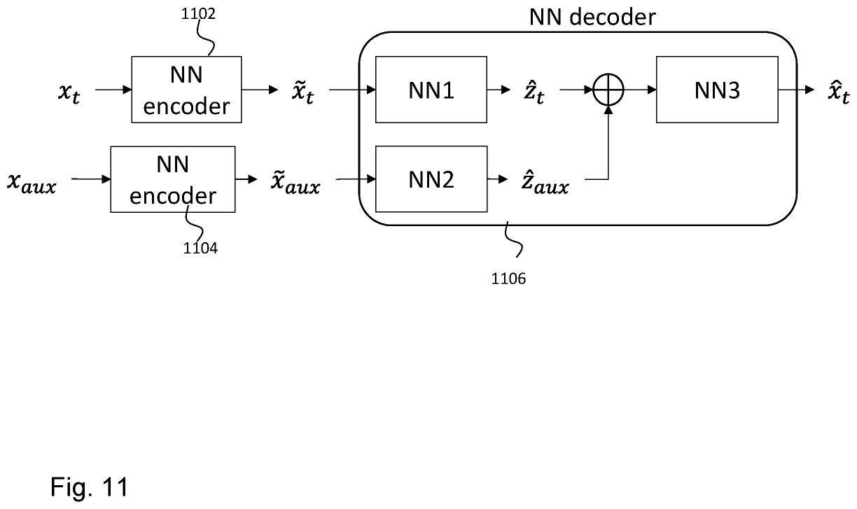

The present disclosure refers to neural network based processor (NNP). According to an embodiment, the NNP is a neural network based in-loop filter. Alternatively, the NNP is a neural network based post-processing filter. Alternatively, as shown in FIG. 11, the NNP is part of an end-to-end learned neural network based decoder, or one of the neural networks in an end-to-end learned neural network based decoder.

FIG. 11 illustrates an example where NNP is part of an end-to-end learned neural network based decoder. x, is a video frame to be coded by a neural network based encoder “NN encoder” 1102 at a certain (low) quality; xₐᵤₓ is a video frame to be coded by a neural network based encoder “NN encoder” 1104 at higher quality than xₜ. \tilde{x}ₜ and \tilde{x}ₐᵤₓ are the bitstreams representing the compressed versions of xₜ and xₐᵤₓ, respectively; the modules that perform lossless coding and probability estimation are not shown explicitly in FIG. 11 and they are assumed to be part of the NN encoder 1102, 1104 and the NN decoder 1106. The NN encoder 1102 and the NN encoder 1104 may comprise the same encoder or may comprise different encoders. In another example (still illustrated by the same FIG. 11), \tilde{x}ₜ and \tilde{x}ₐᵤₓ are the latent tensors which are output by the NN encoder 1102, 1104 before lossless encoding and that are input to the NN decoder 1106 after lossless decoding.

According to an embodiment, one or more data units, or features extracted from one or more data units, are motion-compensated. The motion-compensated data units or motion-compensated features may then be used as auxiliary DUs or as auxiliary features. In one example, the motion compensation operation may be performed as follows: a motion map is computed based at least on the target DU, the auxiliary DU, an algorithm such as the optical flow algorithm; a warping operation is performed based at least on the motion map and the auxiliary DU. In another example, the motion compensation operation may be performed as follows: a motion map is computed based at least on the target features, the auxiliary features, an algorithm such as the optical flow algorithm; a warping operation is performed based at least on the motion map and the auxiliary features. According to another example, the motion compensation operation may be performed as follows: a motion map is computed based at least on the target DU, the auxiliary DU, an algorithm such as the optical flow algorithm; the motion map may be downsampled to match the size of the auxiliary features; a warping operation is performed based at least on the downsampled motion map and the auxiliary features.

According to an embodiment, a target unit is an image or a decompressed image, and auxiliary data units are other images or other decompressed images. According to an example, the auxiliary data units may be images which have similar characteristics as the target DU in terms of content type, object classes, illumination, textures, etc.

According to an embodiment, a target unit is a video frame or a decompressed video frame, and auxiliary data units are other video frames or other decompressed video frames. In one example, the video frames representing the auxiliary data units are contained in the same video as in which the target DU is contained.

In one example, a target unit is a portion of an image or a decompressed portion of an image, and auxiliary data units are other portions of the same image, or other decompressed portions of the same image, or other portions of one or more other images, or other decompressed portions of one or more other images.

According to one embodiment, a target unit is a portion of a video frame or a decompressed portion of a video frame, and auxiliary data units are other portions of the same video frame or other decompressed portions of the same video frame, or other portions of one or more other video frames or other decompressed portions of one or more other video frames.

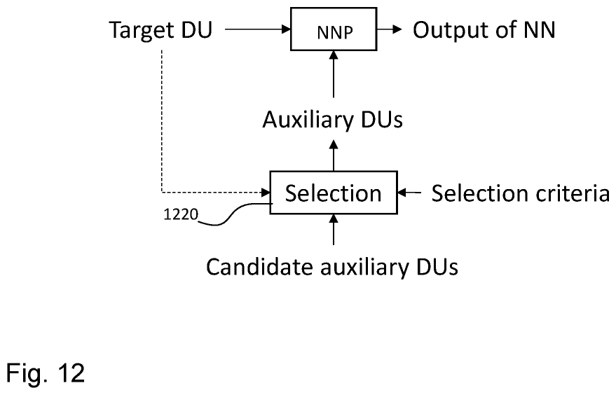

According to an embodiment, the auxiliary data units or the auxiliary features are selected based on one or more selection criteria. FIG. 12 illustrates a high-level example of an embodiment, where selection operation 1220 outputs the auxiliary DUs based at least on one of the following: a target DU, one or more candidate auxiliary DUs, selection criteria. The one or more candidate auxiliary DUs are the DUs from which the auxiliary DUs are selected. Similar operations may be performed for selecting auxiliary features from candidate auxiliary features.

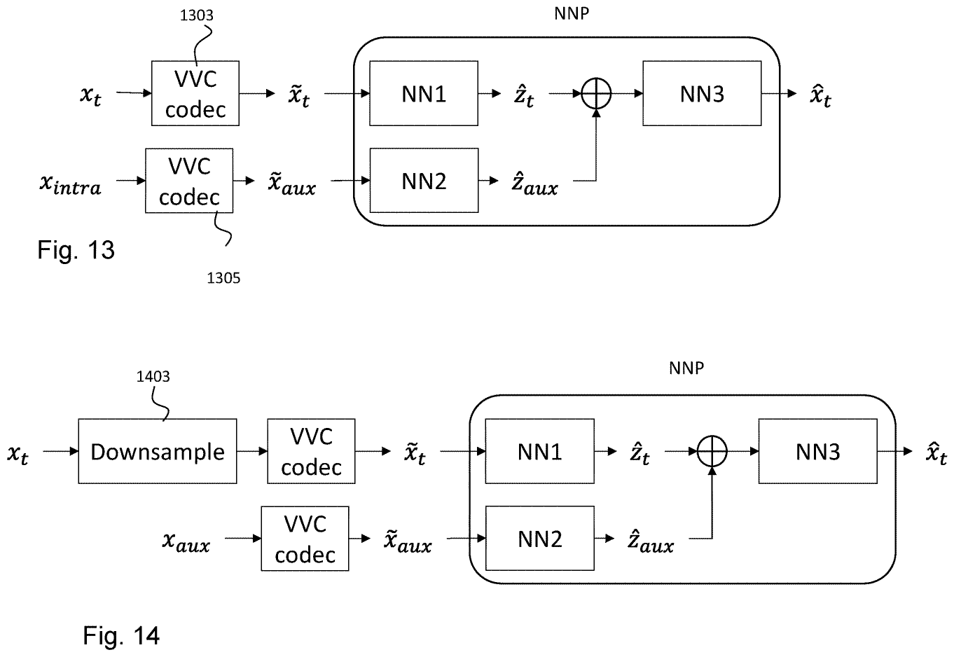

According to an embodiment, the one or more selection criteria comprises selecting the auxiliary data units or auxiliary features that are of higher quality than the target data unit. In one example, the target data unit is a video frame, that was decoded by a video codec such as a codec conforming to the H.266/VC standard; the NNP is a post-processing NN filter; the task of the NNP is to enhance the quality of a video frame decoded by the video codec, for example in terms of Peak Signal-to-Noise Ratio (PSNR); the auxiliary data units are video frames that were coded with higher quality than the target DU, for example by using a lower quantization parameter (QP), such as an intra-coded frame (for example, the intra-coded frame that is closest to the target data unit in output order or in decoding order). FIG. 13 illustrates an example of this embodiment, where xₜ represents a video frame to be coded by means of inter-frame coding, and xᵢₙₜᵣₐ represents a video frame to be coded by means of intra-frame coding. WC codec 1303, 1305 refers to a video codec conforming to the WC/H.266 standard specification. \tilde{x}ₜ denotes the decompressed version of the video frame xₜ, where \tilde{x}ₜ representing the target DU. \tilde{x}ₐᵤₓ denotes the decompressed version of the video frame xᵢₙₜᵣₐ representing the auxiliary DU.

In another example of this embodiment, the target unit is a first decompressed portion of an image that was encoded by an end-to-end learned image codec; the NNP is a neural network decoder that is part of the end-to-end learned image codec; the auxiliary data unit is a second decompressed portion of the same image, encoded by an end-to-end learned image codec at a higher quality than the first decompressed portion; the task of the NNP is to decode the first decompressed portion of an image, by using also information of the second decompressed portion of an image.

According to an embodiment, the one or more selection criteria comprise selecting the auxiliary data units or auxiliary features that are of higher resolution (i.e., sampling rate) than the target data unit. In one example, the target data unit is a video frame that was coded at reduced resolution (e.g., half resolution) by a video codec such as a codec conforming to the H.266/VC standard; the NNP is a post-processing NN that performs upsampling (this operation is sometimes referred to as super-resolution) of the target data unit; the auxiliary data units are video frames that were coded with higher resolution than the target DU. FIG. 14 illustrates this embodiment, where x, represents a video frame to be coded at downsampled resolution, “Downsample” 1403 is a downsampling operation, xₐᵤₓ represents a video frame at original resolution, \tilde{x}ₜ denotes the decompressed version of the video frame x, and represents the target DU, \tilde{x}ₐᵤₓ denotes the decompressed version of the video frame xₐᵤₓ and represents the auxiliary DU.

According to an embodiment, the one or more selection criteria comprise selecting auxiliary DUs or auxiliary features that are part of a certain temporal layer in an inter-frame prediction hierarchy. In one example, where the DUs are video frames decoded by a video decoder, the auxiliary DUs are the frames that are part of a lower temporal layer with respect to the temporal layer of the target frame. Here, the temporal layer refers to a layer in an inter-frame prediction hierarchy of the video decoder, where a frame in the higher temporal layer may be predicted from one or more frames (referred to as reference frames) in the lower temporal layer. However, not all frames in a lower temporal layer may be used as reference frames for predicting a certain frame.

According to an embodiment, the one or more selection criteria comprise selecting auxiliary DUs that are used as reference data for predicting or deriving the target DU. In one example, where the DUs are video frames decoded by a video decoder, the auxiliary DUs are the reference frames that are used for predicting the target frame.

According to an embodiment, the one or more selection criteria comprise selecting the auxiliary DU based at least on one or more of the traditional filters in a video codec. For example, the difference between input and output of ALF, CCALF, DBF, SAO, CC-SAO or any other filter may be used as auxiliary DU information.

According to this embodiment, the difference or residual information obtained based at least on the traditional filters may be scaled and then used as auxiliary information to the NN-based filter. The scaling value(s) may be predetermined, or they can be decided in the encoder and/or decoder side based on rate-distortion optimizations. A signaling mechanism may be incorporated in the process, where the signaling mechanism can indicate an index and/or value of the scaling parameter in the decoder side.

According to an example, the block-level residual information that is the difference between original data and prediction data may be used as additional auxiliary information. The residual information may be scaled prior to using them in the NN filter.

According to one embodiment, the one or more selection criteria comprise selecting the auxiliary data units or auxiliary features with content that is similar to the content of the target DU, according to one or more content similarity criteria.

According to one embodiment, the one or more content similarity criteria comprises computing a distance or distortion metric between the one or more auxiliary DUs and the target DU, or between the one or more auxiliary features and the target features, or between one or more regions of the one or more auxiliary features and one or more regions of the target features. In one example, the distortion metric may be based on the mean-squared error (MSE) metric.

According to one embodiment, the one or more content similarity criteria comprises determining the presence of same or similar object categories or object instances in the one or more auxiliary DUs and the target DU. In one example, a semantic segmentation algorithm (for example, a neural network based semantic segmentation algorithm) may be run on both a target video frame and an auxiliary video frame that has higher quality than the target video frame; the auxiliary video frame is determined to be similar to the target frame if there is a sufficient number of pixels (e.g., based on a predetermined threshold) in the target frame and in the auxiliary frame with same semantic labels assigned by the semantic segmentation algorithm.

According to one embodiment, the one or more content similarity criteria comprises determining whether an auxiliary DU is on the same side as the target DU with respect to a shot boundary. Shot boundary here refers to the position (for example expressed by means of a frame index) in a video sequence where the content changes on average more than in some of the other positions of the video sequence. There may be zero, one or more shot boundaries in a video sequence. In practice, a shot boundary may be present when a predetermined amount of content in video frames changes, or when a switch from a first video camera to a second video camera occurs in the video. According to an example, a shot boundary detection algorithm may be run on some frames of a video sequence, in order to detect the frames where a shot boundary is present: if the position of a target video frame is before (in output order) the shot boundary, at least some of the frames which are before the shot boundary may be considered as auxiliary frames (and vice-versa for the case where the target frame is after the shot boundary).

According to one embodiment, the one or more selection criteria comprises performing a hard attention operation based at least on one or more attention neural networks, where the one or more attention neural networks select one or more subsets of the candidate auxiliary DUs or one or more subsets of the candidate auxiliary features. The hard attention mechanism may comprise a first module that determines the subset, a second module that extracts the determined subset, and a third module that provides the extracted subset as input to the combination operation.

According to an embodiment, the one or more subsets of the candidate auxiliary DUs may comprise one or more spatial regions of the candidate auxiliary DUs, or one or more temporal regions of the candidate auxiliary DUs, or one or more spatio-temporal regions of the candidate auxiliary DUs. In one example, when the DUs are video frames, the subset of auxiliary DUs comprises regions of the auxiliary DUs containing one or more objects belonging to the same category as one or more objects in the target DU.

According to one embodiment, the one or more subsets of the candidate auxiliary features may comprise one or more spatial regions of the candidate auxiliary features, or one or more temporal regions of the candidate auxiliary features, or one or more spatio-temporal regions of the candidate auxiliary features. In one example, the subset of auxiliary features comprises one or more feature channels of the feature tensor representing the auxiliary features.

According to one embodiment, the one or more selection criteria comprises performing a soft attention operation based at least on one or more attention neural networks, where the one or more attention neural networks determine one or more weights, where the determined one or more weights are used for weighting the auxiliary DUs or the auxiliary features, and where the weighted auxiliary DUs or the weighted auxiliary features represent the selected auxiliary DUs or the selected auxiliary features. In one example, the determination of one or more weights may be based at least on one or more neural network layers.

According to one embodiment, the one or more subsets or the one or more weights may be determined based at least on a signal derived based at least on data that is input to a process that was performed on the target DU and on data that is output by the same process. In one example, when the target DU and the auxiliary DUs are video frames decoded by a video codec, the NNP is a post-processing filter, the target DU and the auxiliary DU were obtained based at least on a filter such as an Adaptive Loop Filter (ALF), the subset or the weights are determined based at least on the difference between the target DU (or data from which the target DU is derived) that is input to the ALF and target DU (or data from which the target DU is derived) that is output by the ALF.

According to an embodiment, the target DU may comprise more than one data unit. For example, it may comprise more than one video frame. Correspondingly, the output of the NNP may comprise more than one data unit. For example, the output of the NNP may comprise more than one video frame, which may represent the filtered or decoded versions of the target video frames.

According to an embodiment, the data derived from the features comprises statistical measurement of the features. In one example, the statistical measurements include the channel-wise mean. In another example, the statistical measurements include the channel-wise standard-deviation or variance. In yet another example, the statistical measurements include the Gram matrix, where a Gram matrix may be computed as the dot product between a reshaped feature tensor and the transpose of the reshaped feature tensor, where a reshaped feature tensor is the output of a reshaping operation applied to an input feature tensor and where the reshaping operation combines the spatial axes into a single axis. Sometimes, such reshaping operation may be known as flattening of a matrix. When the statistical measurements include the Gram matrix, the computed Gram matrix may be input to one or more operations (for example, one or more neural network layers) that project the Gram matrix into a Gram tensor whose dimensionality is suitable for allowing a combination of the Gram tensor with other tensors such as feature tensors.

According to one embodiment, the data derived from the features comprises differences between statistical measurements of the target features and statistical measurements of the auxiliary features. In one example, the data derived from the features is obtained by computing the Gram matrix of the target features and the Gram matrix of the auxiliary features, computing the difference between these two Gram matrices, inputting the matrix to one or more operations (for example, one or more neural network layers) that project the difference matrix into a difference tensor whose dimensionality is suitable for allowing a combination of the difference tensor with other tensors such as feature tensors.

According to one embodiment, the impact of the auxiliary DUs or the impact of the auxiliary features may be regulated by one or more regulating values. In one example, the one or more regulating values may be scalar values that multiply the auxiliary DUs or the auxiliary features.

According to one embodiment, the NNP is part of a decoder or is a post-processing operation with respect to a decoder, and the one or more regulating values are determined by an encoder and signaled to the decoder.

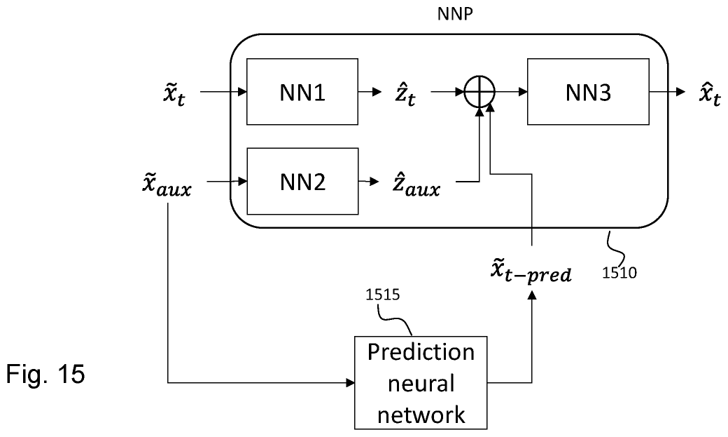

FIG. 15 illustrates an embodiment, where the NNP 1510 takes as input also a prediction of the target DU. The prediction of the target DU may be performed by a prediction neural network 1515 based at least on one or more of the following: one or more DUs, one or more motion-compensated DUs, one or more motion information maps. In FIG. 15, \hat{x}_{t-pred} represents the prediction of the target DU \tilde{x}ₜ.

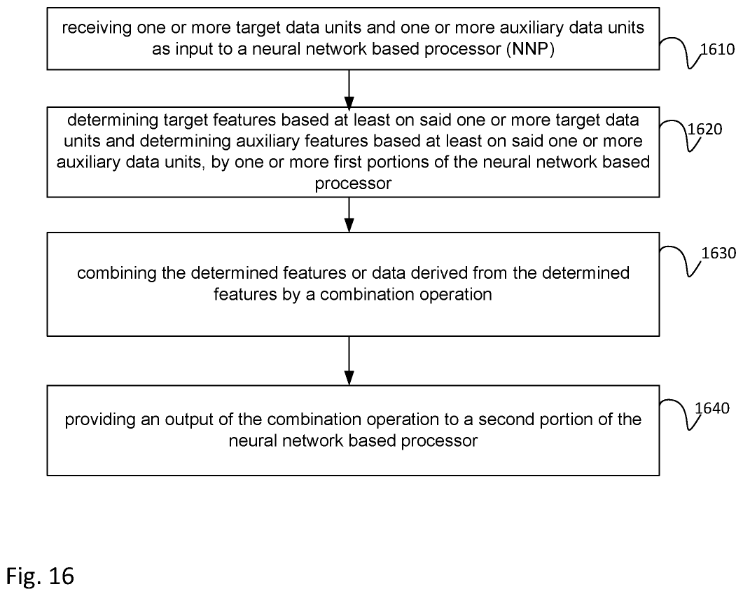

In previous embodiments concerning a neural network architecture using auxiliary data has been discussed. FIG. 16 is a flowchart illustrating a method according to an embodiment. In general, the method comprises receiving 1610 one or more target data units and one or more auxiliary data units as input to a neural network based processor; determining 1620 target features based at least on said one or more target data units and determining auxiliary features based at least on said one or more auxiliary data units, by one or more first portions of the neural network based processor; combining 1630 the determined features or data derived from the determined features by a combination operation; and providing 1640 an output of the combination operation to a second portion of the NNP. Each of the steps can be implemented by a respective module of a computer system.

An apparatus according to an embodiment comprises means for receiving one or more target data units and one or more auxiliary data units as input to a neural network based processor; means for determining target features based at least on said one or more target data units and determining auxiliary features based at least on said one or more auxiliary data units, by one or more first portions of the neural network based processor; means for combining the determined features or data derived from the determined features by a combination operation; and means for providing an output of the combination operation to a second portion of the NNP. The means comprises at least one processor, and a memory including a computer program code, wherein the processor may further comprise processor circuitry. The memory and the computer program code are configured to, with the at least one processor, cause the apparatus to perform the method of FIG. 16 according to various embodiments.

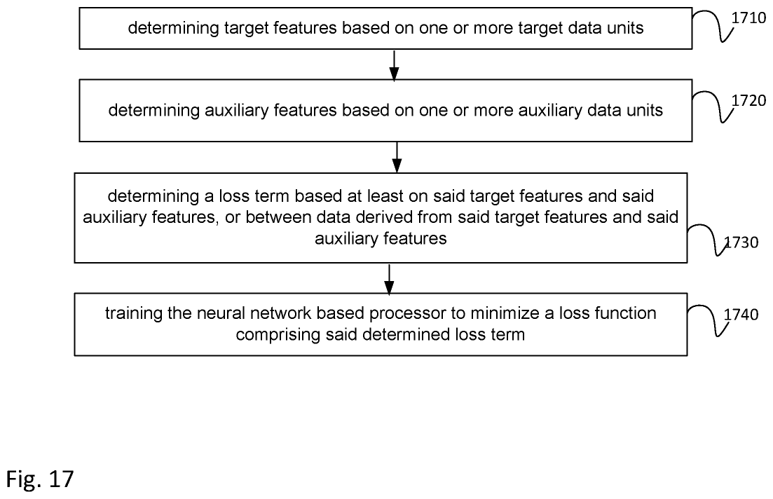

FIG. 17 is a flowchart illustrating a training method according to an embodiment. In general, the method comprises determining 1710 target features based on a target data unit; determining 1720 auxiliary features based on one or more auxiliary data units; determining 1730 a loss term between said target features and said auxiliary features, or between data derived from said target features and said auxiliary features; training 1740 the neural network based processor to minimize a loss function, where the loss function comprises the loss term. Each of the steps can be implemented by a respective module of a computer system.

An apparatus for training a neural network based processor according to an embodiment comprises means for determining target features based on a target data unit; means for determining auxiliary features based on one or more auxiliary data units; means for determining a loss term between said target features and said auxiliary features, or between data derived from said target features and said auxiliary features; means for training the neural network based processor to minimize a loss function, where the loss function comprises the loss term. The means comprises at least one processor, and a memory including a computer program code, wherein the processor may further comprise processor circuitry. The memory and the computer program code are configured to, with the at least one processor, cause the apparatus to perform the method of FIG. 17 according to various embodiments.

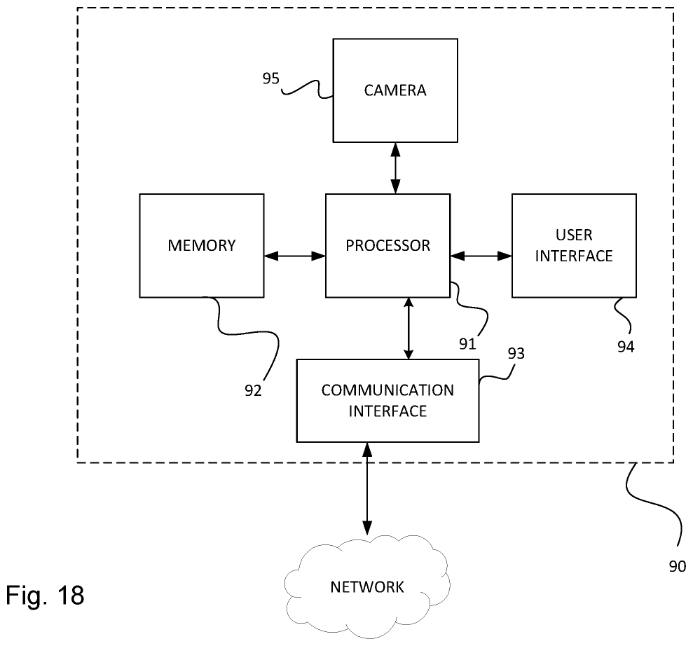

An example of an apparatus is shown in FIG. 18. The apparatus is a user equipment for the purposes of the present embodiments. The apparatus 90 comprises a main processing unit 91, a memory 92, a user interface 94, a communication interface 93. The apparatus according to an embodiment, shown in FIG. 18, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-15. (canceled)

16. An apparatus comprising: at least one processor; and at least one memory storing instructions that, when executed by the at least one processor, cause the apparatus at least to perform: receiving one or more target data units and one or more auxiliary data units as input to a neural network-based processor; determining target features based at least on the one or more target data units, and determining auxiliary features based at least on the one or more auxiliary data units, by one or more first portions of the neural network-based processor; combining the determined features or data derived from the determined features by a combination operation; and providing an output of the combination operation to a second portion of the neural network-based processor.

17. The apparatus according to claim 16, wherein the neural network-based processor is one of the following: neural network-based in-loop filter; neural network-based post-processing filter; end-to-end learned neural network-based decoder; or one of the neural networks in an end-to-end learned neural network-based decoder.

18. The apparatus according to claim 16, wherein the apparatus is further caused to perform: motion-compensating the one or more data units, or features extracted from the one or more data units; and using the motion-compensated data units as the one or more auxiliary data units, or using the motion-compensated features as the auxiliary features.

19. The apparatus according to claim 16, wherein the one or more target data units are one or more of the following: an image, a decompressed image, a video frame, or a decompressed video frame; and wherein the one or more auxiliary data units are one of the following: other images, other decompressed images, other video frames, or other decompressed video frames.

20. The apparatus according to claim 16, wherein the apparatus is further caused to perform: selecting the one or more auxiliary data units or auxiliary features based at least on one or more selection criteria, wherein the selection criteria are based at least on one of the following: a quality of the auxiliary data units; a resolution of the auxiliary data units; location of the auxiliary data units on a certain temporal layer; role of the auxiliary data units as a reference data; content of the auxiliary data units; or a distance of the one or more auxiliary data units compared to the one or more target data units.

21. The apparatus according to claim 20, wherein to select one or more auxiliary data units based at least on one or more selection criteria comprises, and wherein the apparatus is further caused to select the one or more auxiliary data units that have a higher quality than the one or more target data units; or have a higher resolution than the one or more target data units; or are part of a lower temporal layer with respect to the one or more target data units; or have similar content as the one or more target data units.

22. The apparatus according to claim 20, wherein to select one or more auxiliary data units based at least on one or more selection criteria comprises, and wherein the apparatus is further caused to select the one or more auxiliary data units by performing a hard or a soft attention operation based at least on one or more attention neural networks, wherein the result of the attention operations functions as a selection criterion.

23. An apparatus comprising: at least one processor; and at least one memory storing instructions that, when executed by the at least one processor, cause the apparatus at least to perform: determining target features based at least on one or more target data units; determining auxiliary features based at least on one or more auxiliary data units; determining a loss term based at least on the target features and the auxiliary features, or data derived from the target features and the auxiliary features; and training a neural network-based processor to minimize a loss function comprising the determined loss term.

24. A method comprising: receiving one or more target data units and one or more auxiliary data units as input to a neural network-based processor; determining target features based at least on the one or more target data units, and determining auxiliary features based at least on the one or more auxiliary data units, by one or more first portions of the neural network-based processor; combining the determined features or data derived from the determined features by a combination operation; and providing an output of the combination operation to a second portion of the neural network-based processor.

25. The method according to claim 24, wherein the neural network-based processor is one of the following: neural network based in-loop filter; neural network-based post-processing filter; end-to-end learned neural network-based decoder; or one of the neural networks in an end-to-end learned neural network-based decoder.

26. The method according to claim 24, further comprising: motion-compensating the one or more data units, or features extracted from the one or more data units; and using the motion-compensated data units as the one or more auxiliary data units or using the motion-compensated features as the auxiliary features.

27. The method according to claim 24, wherein the one or more target data units are one or more of the following: an image, a decompressed image, a video frame, or a decompressed video frame; and wherein the one or more auxiliary data units are one of the following: other images, other decompressed images, other video frames, or other decompressed video frames.

28. The method according to claim 24, further comprising: selecting one or more auxiliary data units or auxiliary features based at least on one or more selection criteria, wherein the selection criteria are based at least on one of the following: a quality of the auxiliary data units; a resolution of the auxiliary data units; location of the auxiliary data units on a certain temporal layer; role of the auxiliary data units as a reference data; content of the auxiliary data units; or a distance of the one or more auxiliary data units compared to the one or more target data units.

29. The method according to claim 28, wherein selecting one or more auxiliary data units based at least on one or more selection criteria comprises selecting the one or more auxiliary data units that have a higher quality than the one or more target data units; or have a higher resolution than the one or more target data units; or are part of a lower temporal layer with respect to the one or more target data units; or have similar content as the one or more target data units.

30. The method according to claim 28, wherein selecting one or more auxiliary data units based at least on one or more selection criteria comprises selecting the one or more auxiliary data units by performing a hard or a soft attention operation based at least on one or more attention neural networks, wherein the result of the attention operations functions as a selection criterion.
